(19) United States
(12) Patent Application Publication
(10) Pub. No.: US 2004/0225030 A1
(43) Pub. Date: Nov. 11, 2004

(54) Liquid ink composition and preparation of the same

(75) Inventors: Kyung-yol Yon, Gyunggi-do (KR); Nam-jeong Lee, Suwon-city (KR); Hae-ree Joo, Seoul (KR); Joong-hwan Choi, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/771,410

(22) Filed: Feb. 5, 2004

(30) Foreign Application Priority Data
May 6, 2003 (KR) 2003-28616

(51) Int. Cl. G03G 9/13; C09D 11/00; C03C 17/00

(52) U.S. Cl. 523/160; 430/114; 106/31.41; 106/31.73; 523/161

(57) ABSTRACT

A liquid ink composition and a method for producing the same, wherein the liquid ink composition includes a colorant, a charge control agent to regulate electrostatic properties of the colorant, and an organosol to disperse and bind the colorant and the charge control agent. The colorant may be coated with a thermoplastic resin to improve binding with the organosol. By coating the colorant with the thermoplastic resin, the affinity of the colorant for the organosol is facilitated, increasing a size of particles in the liquid ink composition, so that the control of the particles improves the image quality, and micro particles of the carbon black pigment alone do not substantially exist in the printer to prevent printing on a non-image area, thus producing a clear printed image and preventing contamination of other parts in the printer during printing.

### CROSS-REFERENCE TO RELATED APPLICATIONS

This application claims the benefit of Korean Patent Application No. 2003-28616 filed May 6, 2003 in the Korean Intellectual Property Office, the disclosure of which is incorporated herein by reference.

### BACKGROUND OF THE INVENTION

1. Field of the Invention

The present invention generally relates to a liquid ink composition comprising a colorant, a charge control agent and an organosol, and a method for producing the same. More particularly, it relates to a liquid ink composition with improved image quality, in which carbon black as a colorant is coated with a thermoplastic resin to improve compatibility with an organosol.

2. Description of the Related Art

Liquid inks are widely used in offset, rotogravure, ink jet or electrophotographic printings. Many of the properties of the liquid inks required for the respective printing processes are the same though the final ink formulations may be substantially different. For example, ink generally exists in a liquid phase which freely flows during an ink deposition step of a printing process, but performs instantaneous self-fixing to be printed on a final receiving medium permanently and clearly without contamination.

In electrophotographic applications, including copying machines, laser printers, facsimiles, etc., liquid inks are implemented in liquid toners or developers. Generally, the electrophotographic process includes forming a latent electrostatic image on a charged photoconductor (or photosensitizer) by exposing the photoconductor to radiation according to an image patterning method; contacting the photoconductor with a liquid developer to develop the image; and finally transferring the developed image onto a liquid developer receiving medium. The final transfer may be directly or indirectly performed through an intermediate transport member, in which the developed image is generally fused permanently onto the receiving medium by heat and/or pressure.

The liquid toners include an electrostatically insulating liquid colorant which may serve as a carrier to disperse charged particles, also known as toner particles, and contains a polymeric binder. A charge control agent is a component of the liquid developer to regulate the polarity and magnitude of the charge on the toner particles. The liquid toners may be classified into two types: liquid toners generally prepared using compatible resins and organosol toners. The organosol toners make use of a self-stable organosol as a polymeric binder to promote self-fixing of a developed latent image. Owing to the self-stability, the public is increasingly interested in use and research of the organosol toner.

The self-stable organosols comprise colloidal particles of a polymeric binder, wherein the particles have a particle diameter in the range of 0.1 to 1 μm. The polymeric binder is typically synthesized by non-aqueous dispersion polymerization in a low dielectric hydrocarbon solvent. The organosol particles are sterically stabilized with respect to aggregation by the use of a non-physically absorbed, or chemically grafted, soluble polymer.

The most commonly used non-aqueous dispersion polymerization is a free radical polymerization carried out when ethylenically-unsaturated (typically acrylic) monomers, soluble in a hydrocarbon medium, are polymerized in the presence of a preformed amphipathic polymer. The preformed amphipathic polymer, commonly referred to as the stabilizer, has two distinct functional blocks: one block is essentially insoluble in the hydrocarbon medium, but the other block is freely soluble. When the polymerization proceeds, monomers are frictionally converted to a polymer. When the molecular weight of the produced polymer reaches a critical molecular weight, the solubility limit is exceeded, and the polymer precipitates from solution, forming core particles. Then, the amphipathic polymer either adsorbs onto or covalently bonds to the core particles, which continuously grow to form discrete particles. The particles continue to grow until the monomer is depleted. The adsorbed amphipathic polymer shell acts to sterically-stabilize the growing core particles without aggregation.

Consequently, the produced core/shell polymer particles form a self-stable, non-aqueous colloidal dispersion (organosol) comprising peculiar spherical particles having a diameter in the range of 0.1 to 0.5 μm.

Subsequently, the organosols may be converted into a liquid toner by incorporation of a colorant (pigment), a charge director (also referred to as a charge control agent), followed by high shear homogenization, ball-milling, attritor milling, high energy bead (sand) milling or other means which are known in the art for affecting particle size determination in a dispersion. The application of mechanical energy in the milling of the dispersion prevents aggregation of pigment particles to form primary particles (having a diameter in the range of 0.05 to 1.0 μm) and to break down the organosol into fragments which can adhere to the newly-formed pigment surface. The charge director may be physically or chemically adsorbed onto the pigment particles, the organosol or both. As a result, a sterically-stabilized, charged, nonaqueous pigment dispersion is formed, in which particles have a diameter in the range of 0.1 to 2.0 μm, along with toner particles having a diameter in the diameter range of 0.1 to 0.5 μm. Such a sterically stabilized dispersion is ideally used to produce a high-resolution image.

U.S. Pat. No. 5,652,282 and U.S. Pat. No. 5,886,067 relate to liquid inks using organosols and specifically present an explanation of properties and preparation of organosols.

Liquid inks comprising an organosol are limited in actual use, despite the advantages that produce a high resolution image, because the organosol has poor affinity with other components in the liquid inks. Specifically, liquid inks for electrophotographic apparatuses comprise a colorant, an organosol, a charge control agent and a carrier liquid for dispersion. Among the liquid inks, cyan, magenta and yellow inks use organic pigments as colorants, while carbon black pigments mainly used in black inks have different properties from other organic pigments. Carbon black, which is powdery carbon obtained by combination of pyrolysis and incomplete combustion of a hydrocarbon such as natural gas or petroleum, is differentiated into channel black, thermal black and furnace black, according to the method of preparation. Generally, carbon black, which is fine particles having a large surface area, has its own cohesive power that is greater than its affinity for other materials. Also, though carbon black has functional groups such as a carboxyl group, a phenolic hydroxyl group, a lactone group, a carbonyl group and the like on its surface, the number of the functional groups of carbon black per unit area is considerably smaller than the number of functional groups of organic pigments in general. Therefore, carbon black has a poor affinity for common resins, particularly organosols. Consequently, when a liquid ink comprising an organosol is a black ink containing a carbon black pigment, the carbon black pigment fails to bind to the organosol, but forms a large amount of small particles composed of the pigment alone in the ink. In other words, when an organosol serving as a binder and also a dispersion agent is contained in a black ink comprising a carbon black pigment, the organosol cannot sufficiently function as a binder for the carbon black pigment. Meanwhile, the small particles of the pigment alone existing in the black ink are too small to be electrically controlled. They are attached to a undesired non-image area on a photoconductor and transferred to paper, thus producing an unclear image upon printing and causing deterioration of the image quality and contamination of other parts in the printer. Therefore, a black ink using a carbon black pigment has been limited in the use of an organosol, despite the advantages of the organosol, and research to improve the affinity of an organosol with a carbon black pigment in a black ink, and thus improve the image quality has been continuously conducted.

Meanwhile, JP2001-214089 discloses a method to prepare a carbon black for ink jet printing by coating the carbon black with a urethane group or an epoxy resin. However, the carbon black pigment to be dispersed in the ink for ink jet printing should have a small size. Therefore, the disclosed invention is directed to increasing dispersibility and is different from the present invention, which is directed to improving the affinity of a carbon black pigment for an organosol in a black liquid ink comprising the organosol.

### SUMMARY OF THE INVENTION

Accordingly, to solve the above-described and/or other problems, it is an aspect of an embodiment of the present invention to provide a liquid ink composition, and a method for using same, using an organosol, in which a carbon black pigment as a colorant is coated with a thermoplastic resin to improve affinity for the organosol and thus, to increase the size of particles existing in the liquid ink so that the particles may be readily electrically controlled, whereby the carbon black pigment is prevented from being attached to a undesired non-image area on a photoconductor and being transferred to paper. Thus, a clear image is produced upon printing, image quality is improved and contamination of other parts is prevented in a printer.

To accomplish the above and/or other aspects and/or other features of the present invention, a liquid ink composition comprises a colorant; a charge control agent to regulate electrostatic properties of the colorant; and an organosol to disperse and bind the colorant and the charge control agent, in which the colorant is coated with a thermoplastic resin to improve binding to the organosol.

Preferably, the colorant is coated with the thermoplastic resin in an amount in the range of 150 weight parts to 350 weight parts based on 100 weight parts of the colorant.

Preferably, the organosol is contained in the range of 180 to 250 weight parts based on 100 weight parts of the colorant coated with the thermoplastic resin.

Preferably, the colorant is a carbon black.

Preferably, the thermoplastic resin to coat the colorant is any one selected from the group consisting of polyethylene vinylacetates, polyethylene vinylacetate/acetic acid terpolymers, polyethylene acrylic acid copolymers, polyethylene methacrylic acid copolymers, polyethylene acrylate copolymers, polyethylene methacrylate copolymers, polyacrylate resins, polymethacrylate resins, polystyrene acrylic acid copolymers, polystyrene methacrylic acid copolymers, polystyrene acrylate copolymers, polystyrene methacrylate copolymers, rosin ester-based resins and modified rosins.

Preferably, the organosol comprises a carrier liquid and a graft copolymer comprising a (co)polymeric steric stabilizer covalently bonded to a thermoplastic (co)polymeric core which is insoluble in the carrier liquid, in which the thermoplastic (co)polymeric core contains at least one unit derived from polymerizable monomer selected from the group consisting of (meth)acrylate monomers having aliphatic amino radicals, nitrogen containing heterocyclic vinyl monomers, N-vinyl substituted ring-like amide monomers, aromatic substituted ethylene monomers containing amino radicals and nitrogen-containing vinylether monomers.

Also, to achieve the above and/or other aspects, the method to produce a liquid ink composition according to the present invention comprises: coating a colorant with a thermoplastic resin; and mixing and dispersing the coated colorant, an organosol and a charge control agent.

Preferably, the colorant is a carbon black.

Preferably, the thermoplastic resin used to coat the colorant is any one selected from the above-described thermoplastic resins.

Preferably, the organosol comprises a carrier liquid and a graft copolymer comprising a (co)polymeric steric stabilizer covalently bonded to a thermoplastic (co)polymeric core which is insoluble in the carrier liquid, and has the construction as described above for the organosol.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a schematic view showing the pure carbon black pigment bonded to the charge control agent;

FIG. 1B is a schematic view showing the pure carbon black pigment, the charge control agent and the organosol, which are bonded to each other;

FIG. 2 shows the carbon black pigment coated with a thermoplastic resin according to an embodiment of the present invention bonded to the organosol;

FIG. 3 is a graph showing the distribution of particles existing in a liquid ink composition comprising a pure carbon black pigment and an organosol;

FIG. 4 is a graph showing the distribution of particles existing in the liquid ink composition prepared according to an example of the present invention;

FIG. 5A shows an image printed using a liquid ink composition comprising a pure carbon black pigment and an organosol; and

FIG. 5B shows an image printed using the liquid ink composition prepared according to an example of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinbelow, the present invention is described in greater detail.

The liquid ink composition according to an embodiment of the present invention comprises a colorant, a charge control agent to regulate electrostatic properties of the colorant and an organosol to disperse and bind the colorant and the charge control agent, in which the colorant is coated with a thermoplastic resin to improve affinity for organosol.

Examples of commonly used colorants include carbon black, aniline blue, calco oil, chrome yellow, ultramarine blue, Dupont oil red, quinoline yellow, methylene blue chloride, phthalocyanine blue, malachite green oxalate, lamp black, rose Bengal and a mixture of two or more thereof. Preferably, the carbon black is used as the colorant of the liquid ink composition according to an embodiment of the present invention because other pigments do not have problems associated with affinity for an organosol, while the carbon black pigment may form a large amount of particles comprising the carbon black pigment alone in the liquid ink composition, owing to poor affinity for the organosol, causing problems associated with difficulty in electrically controlling the carbon black pigment.

The carbon black which may be used in an embodiment of the present invention includes carbon black manufactured by, for example, the furnace method, the contact method, and the acetylene method . To be more specific, usable carbon blacks are described on pages 290, 291 and 294 of “Handbook of Carbon Black” published in April, 1995. Examples of commonly used carbon blacks include MONARCH® series and REGAL® series supplied from CABOT, RAVEN® series supplied from COLUMBIAN CHEMICALS, NIPEX® series and SPEZIALSCHWARZ® series supplied from DEGUSSA and EK8200 supplied from AZTECH.

Examples of the thermoplastic resin to coat the colorant include vinyl chloride resins, vinylidene chloride resins, vinyl acetate resins, polyvinyl acetal resins, styrene-based resins, methacrylic acid-based resins, polyolefin resins, polyacrylate resins, polyester resins, epoxy-based resins, urethane-based resins and the like. The preferred thermoplastic resins to coat the colorant in the liquid ink composition according to an embodiment of the present invention are olefin-based resins containing a carboxyl group or an ester group because the organosol typically comprises a copolymer composed of acrylate or methacrylate, in which both acrylate and methacrylate have —COOR as a side chain attached to an olefinic main chain. In other words, the organosol is an olefin resin having an ester group in a broad sense. Therefore, to have affinity for the organosol, resins having a similar structure to the organosol, i.e., olefin-based resins are preferably used. Preferred examples of these olefin-based resins may include any one thermoplastic resin selected from an polyethylene vinylacetate, polyethylene vinylacetate/acetic acid terpolymers, polyethylene acrylic acid copolymers, polyethylene methacrylic acid copolymers, polyethylene acrylate copolymers, polyethylene methacrylate copolymers, polyacrylate resins, polymethacrylate resins, polystyrene acrylic acid copolymers, polystyrene methacrylic acid copolymers, polystyrene acrylate copolymers, polystyrene methacrylate copolymers, rosin ester-based resin and modified rosin ester-based resins, but are not limited thereto.

In the liquid ink composition, the organosol acts as a binder and also a dispersion agent for the colorant and the charge control agent. Generally, the binder which may be used in an embodiment of the present invention includes polyester resins, styrene-based resins, acrylic acid esters, methacrylic acid esters, homopolymers of vinyl monomer or copolymers with styrene thereof, epoxy resins, polyester resins, polyurethane resins and the like. Also, examples of the dispersion agent which is commonly used in the art include polyolefins, polyvinylalcohols, polyvinyl methylethers, polyvinyl ethylethers, polyethyleneoxides, gelatine, methyl cellulose, methylhydroxypropyl cellulose, ethyl cellulose, sodium salts of carboxylmethyl cellulose, starch, nitrogen-containing polymers or acid-containing polymers. The nitrogen-containing polymers include at least one of polyvinylpyrrolidon, polyamine, polyethyleneamine, amine group-containing poly(meth)acrylate, copolymers of amine group-containing alkyl(meth)acrylate and (meth)acrylate and derivatives thereof which are soluble in a hydrocarbon.

The organosol, which is a substance used in the liquid ink composition to perform complex functions of a binder and a dispersion agent, comprises a carrier liquid and a graft copolymer comprising a (co)polymeric steric stabilizer covalently bonded to a thermoplastic (co)polymeric core which is insoluble in the carrier liquid, in which the thermoplastic (co)polymeric core preferably contains at least one unit derived from polymerizable monomer selected from the group consisting of (meth)acrylates having aliphatic amino radicals, nitrogen containing heterocyclic vinyl monomers, N-vinyl substituted ring-like amide monomers, aromatic substituted ethylene monomers containing amino radicals and nitrogen-containing vinylether monomers. Herein, the content of the carrier liquid is 300 to 3,000 weight parts, based on 100 weight parts of the total weight of monomers forming the thermoplastic (co)polymeric core. When the content of the carrier liquid exceeds the above-described range, dispersing properties of the organosol are undesirably deteriorated.

Preferably, the carrier liquid constituting the organosol has a Kauri-Butanol number of 30 or less. “Kauri-Butanol” refers to an ASTM Test Method D1133-54T. The Kauri-Butanol Number (KB) is a measure of the tolerance of a standard solution of kauri resin in 1-butanol to an added hydrocarbon diluent and is expressed by the volume (ml) at 25° C. of the solvent required to produce a predetermined degree of turbidity when added to 20 g of a standard kauri-1-butanol solution.

The carrier liquid may be selected from a wide variety of materials which are known in the art. Among the materials, a material having a Kauri-butanol number of 30 or less may be preferably used. The carrier liquid is generally oleophilic, chemically stable and electrically insulating. The electrically insulating liquid refers to a liquid having a low dielectric constant and a high electrical resistivity. Such liquid has a dielectric constant of 5 or less, particularly, 1 to 5, more preferably 1 to 3. Electrical resistivities of carrier liquids are 10⁹ Ω or more, more preferably 10¹⁰ Ω or more, particularly 10¹⁰ to 10¹⁶ Ω.

The polymer particles in the organosol of an embodiment of the present invention comprise an amphipathic copolymer. The amphipathic copolymer contains a soluble or marginally insoluble high molecular weight (co)polymer steric stabilizer covalently bonded to an insoluble, thermoplastic (co)polymeric core. When the stabilizer is 3,3,5-trimethylcyclohexyl methacrylate, the dispersed toner particles show superior stability.

The more specific descriptions of the organosol are given in U.S. Pat. No. 5,652,282 or U.S. Pat. No. 5,886,067 and others known to the art also may be used in the liquid ink composition of embodiments of the present invention.

The organosol is a copolymer composed of acrylate or methacrylate. Both acrylate and methacrylate have a main-chain of olefin and a side chain of —COOR group attached to the main chain. Therefore, in a broad sense, the organosol is an olefin-based resin containing an ester group. A compound that is compatible with such an organosol preferably has a structure similar to the structure of the organosol. Thus, the thermoplastic resin for coating the colorant may be readily bonded to the organosol since the carboxyl group or ester group in the resin has effective affinity for the —COOR group of the organosol, and the colorant coated with the thermoplastic resin shows improved affinity for the organosol.

The liquid ink composition according to an embodiment of the present invention comprises a charge control agent. The charge control agent provides uniform charge polarity for a developer, that is, particles in the liquid ink composition. The content of the charge control agent is generally at a level commonly used in electrophotographic image forming apparatuses.

The charge control agent may be incorporated into the developer particles by a variety of methods, such as chemically reacting the charge control agent with the developer particles, chemically or physically adsorbing the charge control agent onto the developer particles, or chelating the charge control agent to a functional group incorporated into the toner particles. The charge control agent acts to impart an electrical charge of a certain polarity onto the developer particles, and any of charge control agents known to the art may be used in an embodiment of the present invention.

For example, the charge control agent may be introduced in the form of metal salts comprising polyvalent metal ions and organic anions as the counterion. Examples of suitable metal ions include Ba(II), Ca(II), Mn(II), Zn(II), Cu(II), AI(III), Cr(III), Fe(II), Fe(III), Sb(III), Bi(III), Co(II), La(III), Pb(II), Mg(II), Mo(III), Ni(II), Ag(I), Sr(II), Sn(IV), V(V), Y(III) and Ti(IV). Examples of suitable organic anions include carboxylates or sulfonates derived from aliphatic or aromatic carboxylic or sulfonic acids.

Also, examples of positive charge control agents are the metallic carboxylates (soaps) described in U.S. Pat. No. 3,411,936, which include alkaline earth- and heavy-metallic salts of fatty acids having at least 6 to 7 carbon atoms and cyclic aliphatic acids containing naphthenic acid. More preferably, it is polyvalent metal soaps of zirconium and aluminum, particularly the zirconium soap of octanoic acid (Zirconium HEX-CEM from MOONEY CHEMICALS).

Methods to coat carbon black with the thermoplastic resin include a method comprising mixing the carbon black and the thermoplastic olefin resin using a mixer such as a kneader, followed by freeze-milling and a method comprising dissolving the thermoplastic olefin resin in a solvent to form a solution, dispersing a carbon black in the solution and removing the solvent. The latter method is similar to the method disclosed in JP2001-214089, in which a resin is dissolved in a solvent while heating, the resulting resin solution is mixed with a suspension of a carbon black in water while stirring, and the carbon black is coated with urethane group or epoxy resin by separation of the carbon black from water to prepare a carbon black for ink jet printing. However, the invention disclosed in the patent improves dispersion properties of a carbon black for ink jet printing, and thus is different from embodiments of the present invention which improve affinity of a carbon black pigment with an organosol by coating carbon black particles with a thermoplastic resin.

Now, the present invention is explained in detail referring to the following Examples.

### EXAMPLES

350 g of carbon black and 650 g of rosin ester resin were mixed with a kneader, followed by freeze-grinding to obtain carbon black coated with the rosin ester resin. Then, 25 g of the resin-coated carbon black, 381 g of an organosol, 293 g of Norpar 12 and 1.27 g of Zirconium-HEXCEM were put to a milling vessel and 1200 g of zirconium beads were added thereto and milled at 42° C. by stirring at a speed of 4500 rpm for 3 hours to form a liquid ink composition.

### Comparative Example

11 g of carbon black, 521 g of an organosol, 168 g of Norpar 12 and 0.33 g of Zirconium-HEXCEM were put into a milling vessel and 1350 g of zirconium beads were added thereto and milled at 42 by stirring at a speed of 4500 rpm for 3 hours to form a liquid ink composition.

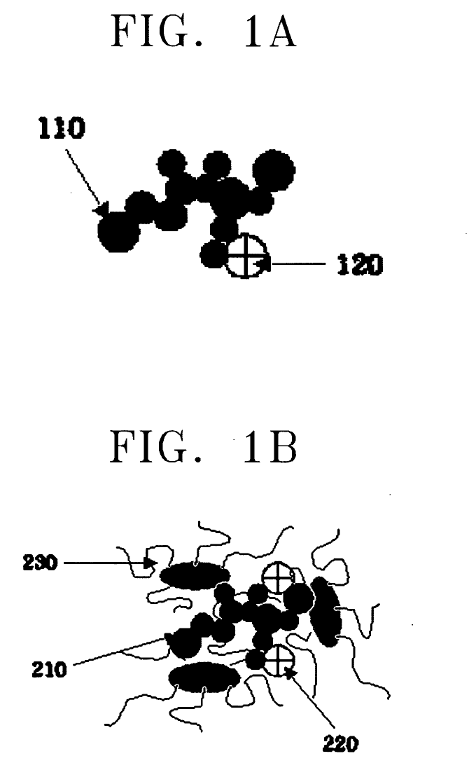

FIG. 1A is a view showing the pure carbon black pigment 110 bonded to the charge control agent 120 and FIG. 1B is a view showing the pure carbon black pigment 210, the charge control agent 220 and the organosol 230, which are bonded to each other, prepared in Comparative Example. As shown in FIG. 1B, since the affinity of the pure carbon black pigment 210 for the organosol 230 was poor, some of the carbon black pigment 210 existed alone.

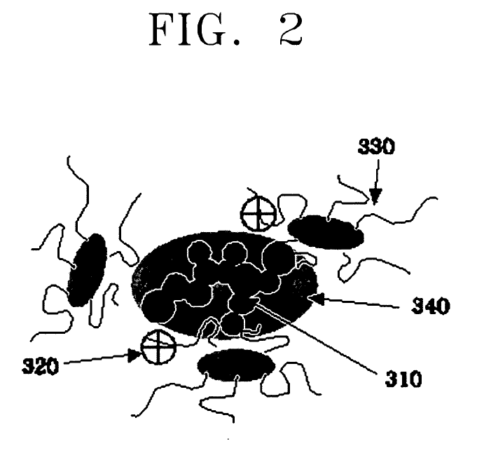

FIG. 2 shows the carbon black pigment 310 coated with a thermoplastic resin 340, the control agent 320 and organosol 330, which are bonded to each other, prepared in Example. The thermoplastic resin 340 coated on the carbon black had good affinity for the organosol 330 and thus, could be readily bonded to the organosol 330. As a result, there was no particle composed of the carbon black pigment alone and particles in the liquid ink composition had increased particle sizes.

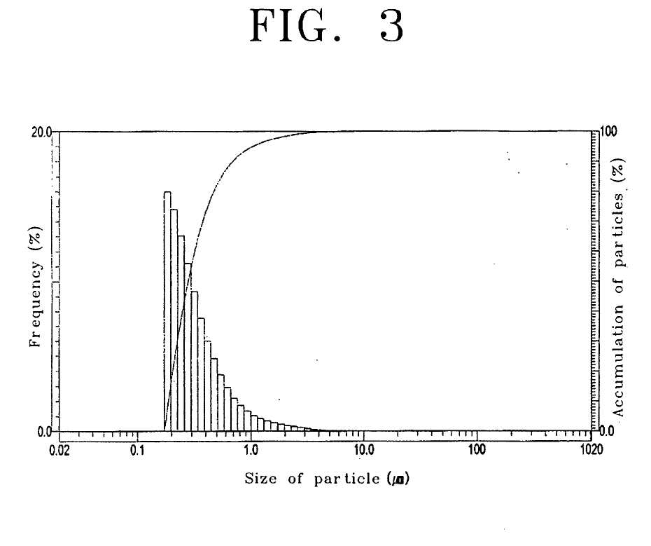

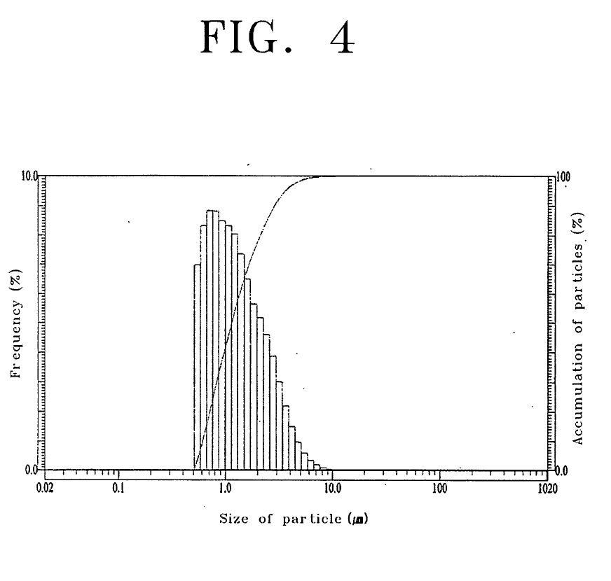

The particle size distributions of the liquid ink compositions from Example and Comparative Example are shown in FIG. 3 and FIG. 4.

FIG. 3 is a graph showing the size distribution of particles existing in the liquid ink composition prepared using a pure carbon black pigment in Comparative Example. As shown in FIG. 3, small particles having a particle diameter of about 0.2 μm were prevalent to particles of other sizes. Such small carbon black particles can be readily transferred by an electrical power and other external disturbance. Therefore, it is hard to electrically control them, thereby causing production of unclear image and contamination of other parts in a printer.

FIG. 4 is a graph showing the distribution of particles existing in the liquid ink composition prepared using the carbon black pigment coated with a thermoplastic resin in Example. As shown in FIG. 4, by using the carbon black which had been previously coated with a thermoplastic resin having good affinity for an organosol, particles of the carbon black pigment alone were not observed in the liquid ink composition, and particles are electrically controlled, producing a clear image.

As is seen from the comparison of FIG. 3 and FIG. 4, depending upon whether a carbon black pigment is coated with a thermoplastic resin, the distribution of small particles in the liquid ink composition is changed, and small particles (diameter of 0.5 μm or less) substantially do not exist in the liquid ink composition prepared, as in the Example.

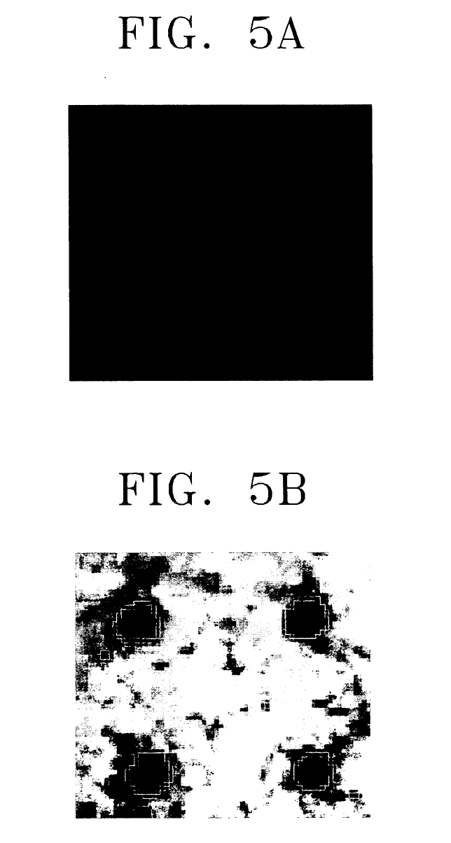

FIG. 5A shows an image printed using the liquid ink composition prepared according to Comparative Example, and FIG. 5B shows an image printed using the liquid ink composition prepared according to the Example. As may be seen from the images of FIGS. 5A and 5B, the image using the liquid ink composition according to the Example is much clearer.

Also, the definition of the printed images was examined by measuring BOD (background optical density). As a measured the background OD value is lower, the printed image is clear. The background OD values of the images printed using the inks of the Example and the Comparative Example are shown in Table 1.

TABLE 1

| | Background OD value |
|---|---|
| Example | 0.05 |
| Comparative Example | 0.15 |

As is seen from Table 1, the background OD of the Example is much lower than the background OD of the Comparative Example. Thus, the image printed using the liquid ink composition prepared in the Example was clearer than the image printed using the liquid ink composition prepared in the Comparative Example.

As is described above, according to an embodiment of the present invention, using a liquid ink composition, in which a carbon black is coated with a thermoplastic resin having an affinity for an organosol so that the carbon black may be readily bonded to the organosol, results in an increase of average particle size of particles existing in the liquid ink composition, so that electrical control of the particles is facilitated, improving the definition of a printed image, and preventing the particles of the carbon black pigment alone from existing in a printer, thus preventing contamination of the inside of the printer; and a method for producing the same.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A liquid ink composition comprising:
a colorant;
a charge control agent to regulate electrostatic properties of the colorant; and
an organosol to disperse and bind the colorant and the charge control agent,
in which the colorant is coated with a thermoplastic resin to improve binding to the organosol.

2. The liquid ink composition according to claim 1, wherein the colorant coated with the thermoplastic resin is coated with the thermoplastic resin in a range of 150 weight parts to 350 weight parts based on 100 weight parts of the colorant.

3. The liquid ink composition according to claim 1, wherein the organosol is contained in a range of 180 weight parts to 250 weight parts based on 100 weight parts of the colorant coated with the thermoplastic resin.

4. The liquid ink composition according to claim 1, wherein the colorant is carbon black.

5. The liquid ink composition according to claim 1, wherein the thermoplastic resin to coat the colorant is any one selected from the group consisting of polyethylene vinylacetates, polyethylene vinylacetate/acid terpolymers, polyethylene acrylic acid copolymers, polyethylene methacrylic acid copolymers, polyethylene acrylate copolymers, polyethylene methacrylate copolymers, polyacrylate resins, polymethacrylate resins, polystyrene acrylic acid copolymers, polystyrene methacrylic acid copolymers, polystyrene acrylate copolymers, polystyrene methacrylate copolymers, rosin ester resins and modified rosins.

6. The liquid ink composition according to claim 1, wherein the organosol comprises:
a carrier liquid; and
a graft copolymer comprising a (co)polymer steric stabilizer covalently bonded to a thermoplastic (co)polymeric core which is insoluble in the carrier liquid,
in which the thermoplastic (co)polymeric core contains at least one unit derived from polymerizable monomer selected from the group consisting of (meth)acrylate monomers having aliphatic amino radicals, nitrogen containing heterocyclic vinyl monomers, N-vinyl substituted ring-like amide monomers, aromatic substituted ethylene monomers containing amino radicals and nitrogen-containing vinylether monomers.

7. A method to produce a liquid ink composition comprising:
coating a colorant with a thermoplastic resin; and
mixing and dispersing the coated colorant, an organosol and a charge control agent.

8. The method to produce a liquid ink composition according to claim 7, wherein the colorant is carbon black.

9. The method according to claim 7, wherein the thermoplastic resin utilized to coat the colorant is any one selected from the group consisting of polyethylene vinylacetates, polyethylene vinylacetate/acid terpolymers, polyethylene acrylic acid copolymers, polyethylene methacrylic acid copolymers, polyethylene acrylate copolymers, polyethylene methacrylate copolymers, polyacrylate resins, polymethacrylate resins, polystyrene acrylic acid copolymers, polystyrene methacrylic acid copolymers, polystyrene acrylate copolymers, polystyrene methacrylate copolymers, rosin ester resins and modified rosins.

10. The method according to claim 7, wherein the organosol comprises:
a carrier liquid; and
a graft copolymer comprising a (co)polymeric steric stabilizer covalently bonded to a thermoplastic (co)polymeric core which is insoluble in the carrier liquid,
in which the thermoplastic (co)polymeric core contains at least one unit derived from polymerizable monomer selected from the group consisting of (meth)acrylate monomers having aliphatic amino radicals, nitrogen containing heterocyclic vinyl monomers, N-vinyl substituted ring-like amide monomers, aromatic substituted ethylene monomers containing amino radicals and nitrogen-containing vinylether monomers.

11. A liquid ink composition comprising:
a colorant having a coating;
a charge control agent to regulate electrostatic properties of the colorant; and
an organosol to disperse and bind the colorant and the charge control agent.

12. The liquid ink composition of claim 11, wherein the coating of the colorant is a thermoplastic resin.

13. The liquid ink composition according to claim 12, wherein the colorant having a coating of the thermoplastic resin is coated with the thermoplastic resin in a range of 150 weight parts to 350 weight parts based on 100 weight parts of the colorant.

14. The liquid ink composition according to claim 11, wherein the organosol is contained in a range of 180 weight parts to 250 weight parts based on 100 weight parts of the colorant having the coating of the thermoplastic resin.

15. The liquid ink composition according to claim 11, wherein the colorant is carbon black.

16. The liquid ink composition according to claim 12, wherein the thermoplastic resin utilized to coat the colorant is any one selected from the group consisting of polyethylene vinylacetates, polyethylene vinylacetate/acid terpolymers, polyethylene acrylic acid copolymers, polyethylene methacrylic acid copolymers, polyethylene acrylate copolymers, polyethylene methacrylate copolymers, polyacrylate resins, polymethacrylate resins, polystyrene acrylic acid copolymers, polystyrene methacrylic acid copolymers, polystyrene acrylate copolymers, polystyrene methacrylate copolymers, rosin ester resins and modified rosins.

17. The liquid ink composition according to claim 11, wherein the organosol comprises:
a carrier liquid; and
a graft copolymer comprising a (co)polymer steric stabilizer covalently bonded to a thermoplastic (co)polymeric core which is insoluble in the carrier liquid,
in which the thermoplastic (co)polymeric core contains at least one unit derived from polymerizable monomer selected from the group consisting of (meth)acrylate monomers having aliphatic amino radicals, nitrogen containing heterocyclic vinyl monomers, N-vinyl substituted ring-like amide monomers, aromatic substituted ethylene monomers containing amino radicals and nitrogen-containing vinylether monomers.
